(19) United States
(12) Patent Application Publication
(10) Pub. No.: US 2026/0298126 A1
(43) Pub. Date: Oct. 1, 2026

(54) SYSTEM AND METHOD FOR MONITORING A BURNER ASSOCIATED WITH AN EXHAUST GAS AFTER-TREATMENT APPARATUS OF A VEHICLE

(71) Applicant: FERRARI S.P.A., MODENA (MO) (IT)

(72) Inventors: Luca BROCCHI, Modena (MO) (IT); Vincenzo ROSSI, Modena (MO) (IT)

(21) Appl. No.: 19/577,973

(22) Filed: Mar. 25, 2026

(30) Foreign Application Priority Data
Mar. 28, 2025 (IT) 102025000006537

(51) Int. Cl. F01N 11/00; F01N 3/20; G01M 15/10

(52) U.S. Cl. CPC F01N 11/007; F01N 3/2033; F01N 3/204; G01M 15/104

(57) ABSTRACT

A monitoring system is described, adapted to monitor the operation of a burner associated with an exhaust gas after-treatment apparatus for exhaust gases produced by an internal combustion engine of a vehicle, comprising: a Lambda probe, coupled to the burner so as to detect information associated with a combustion within the burner; and a processing unit, operatively coupled to the Lambda probe so as to use the information detected by the Lambda probe to indirectly estimate temperature information associated with the burner. The processing unit is adapted to recognize a correct ignition of an air/fuel mixture within the burner and consequently a correct combustion, based on said temperature information.

### CROSS-REFERENCE TO RELATED APPLICATIONS

This patent application claims priority from Italian Patent Application No. 102025000006537 filed on March 28, 2025, the entire disclosure of which is incorporated herein by reference.

### TECHNICAL FIELD

The present solution relates to a system and method for monitoring a burner associated with an exhaust gas after-treatment apparatus of a vehicle.

### BACKGROUND

Vehicles equipped with an internal combustion engine generally comprise an after-treatment apparatus for exhaust gases produced by combustion occurring within the engine, in order to reduce harmful emissions and comply with current pollutant emission regulations.

In particular, it is known that an after-treatment apparatus only works optimally once it has reached an operating temperature above a given threshold temperature.

A solution that has been adopted to speed up reaching of an optimal operating temperature for the aforementioned after-treatment apparatus involves the use of a dedicated burner, placed at the exhaust line.

The burner is provided with: a combustion chamber; an injector to inject fuel into the combustion chamber; an inlet duct to feed compressed air into the combustion chamber to form a mixture with the fuel injected through the injector; an ignition device to ignite the mixture; and an outlet duct to discharge the combustion products, i.e. additional exhaust gases with respect to those produced by the engine.

The outlet duct is in suitable communication with the after-treatment apparatus via an exhaust duct to feed the additional exhaust gases produced by the burner to the after-treatment apparatus, in addition to or instead of the exhaust gases produced by the engine, thereby allowing quicker heating of the after-treatment apparatus by the additional exhaust gases.

Since combustion of the air/fuel mixture is triggered inside the burner, it is particularly important for safety purposes to be able to reliably and promptly monitor whether combustion has taken place or not.

Should the fuel reach the after-treatment apparatus through the outlet duct without burning inside the burner’s combustion chamber, the same fuel would seriously foul the components of the after-treatment apparatus and there would also be a risk of self-combustion outside the combustion chamber, with associated risk of fire.

A diagnosis of successful combustion within the burner can be implemented through the use of an appropriate sensor assembly operatively coupled to the burner, in particular including a Lambda probe or sensor (also known as a UEGO - Universal Exhaust Gas Oxygen sensor) together with an associated thermocouple. Use of this sensor assembly allows to determine the oxygen concentration within the exhaust gas and an associated temperature and thus determine whether combustion has occurred or not.

Although effective, this solution for monitoring combustion inside the burner is rather demanding in terms of the number of components and the associated costs, especially in the case of multi-bank engines. In addition, appropriate diagnostics must be provided to check the integrity of the aforementioned thermocouple, which may in fact be prone to breakage, complicating the control software.

Therefore, there is a general need for a more efficient solution to the above problem of monitoring the operation of the burner associated with the exhaust gas after-treatment apparatus.

### AIM OF THE INVENTION

An object of the present discussion is to provide a solution for monitoring the burner associated with the exhaust gas after-treatment apparatus, which can enable the above requirement to be met, preferably in a simple and reliable manner.

In accordance with the objective stated above, a monitoring system and method are provided, as defined in the appended claims.

### BRIEF DESCRIPTION OF THE FIGURES

The present solution will now be described with reference to the accompanying drawings, which show a non-limiting embodiment thereof, wherein:

- FIG. 1 schematically shows a vehicle provided with an internal combustion engine, in accordance with the present solution;

- FIG. 2 is a schematic diagram of an exhaust gas after-treatment apparatus in the vehicle of FIG. 1 and a monitoring system of a related burner, in accordance with an aspect of the present solution;

- FIGS. 3A-3E show plots of quantities associated with the monitoring system; and

- FIG. 4 is a schematic flow chart of operations performed by the monitoring system.

### DETAILED DESCRIPTION OF FORMS OF IMPLEMENTATION

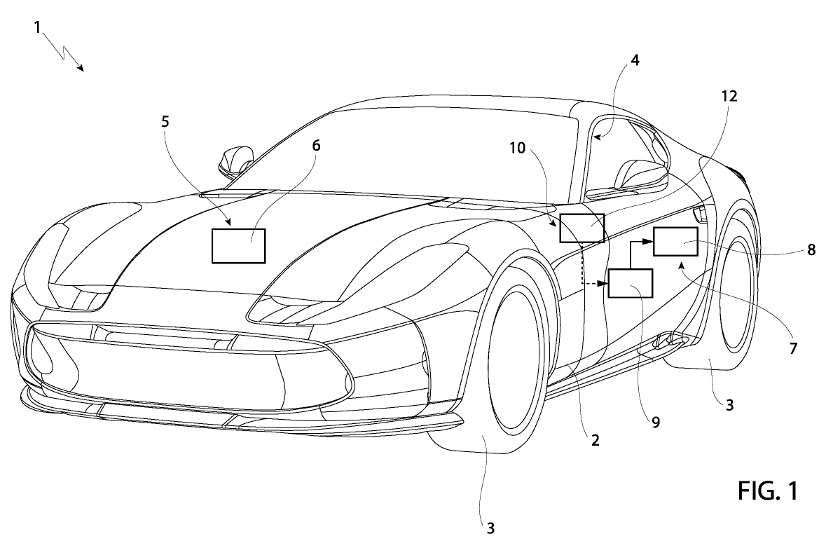

FIG. 1 shows a vehicle, specifically a motor vehicle 1, having a body 2 resting on the ground by means of wheels 3 and defining inside it a compartment 4 for a driver and possible passengers.

As shown schematically, the motor vehicle 1 comprises a propulsion system 5 provided with an internal combustion engine 6 (thermal engine) for the generation of energy, which is transmitted to the wheels 3 for the propulsion of the motor vehicle 1 (the aforementioned propulsion system may possibly also comprise at least one electric motor which is combined with the internal combustion engine to form a hybrid propulsion system).

The motor vehicle 1 further comprises an exhaust system 7, provided in particular with at least one after-treatment apparatus 8 of the exhaust gases produced by the combustion within the engine and a burner 9 associated with the exhaust gas after-treatment apparatus 8.

According to an aspect of the present solution, the vehicle 1 comprises a monitoring system 10, coupled to the burner 9 and configured to monitor its operation, in particular in order to recognize a correct ignition of the air/fuel mixture within the same burner 9.

Such a monitoring system 10 comprises a digital processing unit 12 (microprocessor, microcontroller or the like), configured to implement the monitoring operations; to this end, the digital processing unit 12 comprises a non-volatile memory which stores software instructions (firmware) for implementing the same monitoring operations.

In a possible embodiment, such digital processing unit 12 may coincide with, or be part of, an Electronic Control Unit (ECU) of the motor vehicle 1, designed to monitor the general operation of the same motor vehicle 1 (in a known manner, not illustrated herein), including controlling the operation of the engine 6 and exhaust system 7.

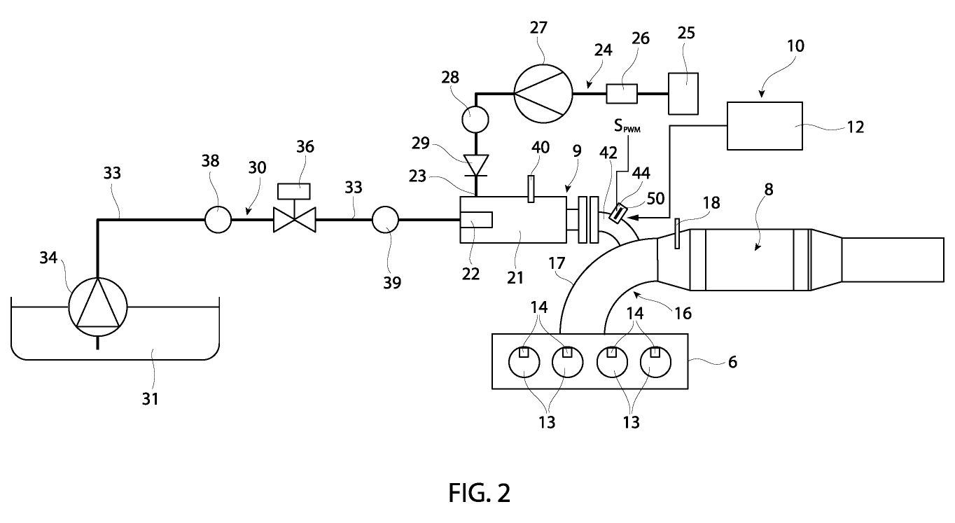

In greater detail, as shown in FIG. 2, the internal combustion engine 6 comprises one or more cylinders defining respective combustion chambers 13 and, for each of the combustion chambers 13, a corresponding injector device 14, that is controlled for injecting a fuel, e.g. petrol or diesel, into the relevant combustion chamber 13.

The injector device 14, as is known, is also configured to be able to prevent fuel from entering the combustion chamber 13, in particular during the operating steps of the combustion engine 6 when the presence of unburned fuel is inappropriate, for example the step of discharging the exhaust gases, following their expansion within the combustion chamber 13.

The after-treatment apparatus 8, which may comprise a particulate filter, a catalytic converter and similar devices for removing harmful components from the exhaust gases, receives at an inlet the exhaust gases of the combustion engine 6, via an exhaust line 16, and supplies at an outlet treated or purified exhaust gases, i.e. gases containing fewer harmful components than the incoming exhaust gases.

The exhaust line 16 comprises one or more exhaust ducts 17 placing in communication or connection an exhaust manifold of the combustion engine 6 with the after-treatment apparatus 8.

The same exhaust line 16 may comprise other components, for example a temperature sensor 18 (capable of providing a corresponding temperature signal), arranged at one of the exhaust ducts 17, upstream of the after-treatment apparatus 8.

The burner 9 comprises at least one combustion chamber 21 and a respective injector device 22 to inject fuel into the combustion chamber; the combustion chamber 21 has an inlet 23 for the oxidant, in this case air.

A supply circuit 24 for supplying combustion fuel to the combustion chamber 21 via said inlet 23 comprises: an oxidant filtration device or air filter 25; a first transducer 26 configured to detect a quantity indicative of a flow rate of the oxidant and to generate a corresponding flow rate signal; a compressor 27, for example of a centrifugal type, to compress the oxidant; a second transducer 28 configured to detect a quantity indicative of a combustion gas pressure and to generate a corresponding signal; and a check valve 29 to prevent a return of the combustion gas from the combustion chamber 21, i.e. in particular towards the compressor 27.

In addition, a supply line 30 is configured to feed a flow of fuel from a tank 31 to the injector device 22.

Such supply line 30 comprises: at least one supply duct 33, which places the fuel tank 31 in communication with the injector device 22; a pumping member or pump 34 configured to draw fuel from the fuel tank 31 and pump the drawn fuel towards the injector device 22, more precisely with a sufficient pressure so that the fuel reaches the injector device 22 and is consequently injected into the combustion chamber 21 with a pressure suitable for combustion; and a valve 36 controllable according to at least a first control mode and a second control mode, wherein the valve 36 respectively allows and prevents a passage of the fuel flow towards the injector device 22.

Furthermore, the supply line 30 comprises a first transducer 38 configured to detect a quantity indicative of a fuel pressure upstream of the valve 36 and generate a corresponding signal; and a second transducer 39 configured to detect a quantity indicative of a fuel pressure downstream of the valve 36 and generate a corresponding signal.

The burner 9 further comprises an ignition device 40 (e.g., a glow plug or spark plug) configured to ignite the combustion of the fuel-oxidant mixture within the combustion chamber 21 and arranged at the same combustion chamber 21.

A respective exhaust duct 42 couples the burner 9 to the after-treatment apparatus 8, feeding the exhaust gases produced by the burner 9 to the same after-treatment apparatus 8 (as mentioned above, in order to cause a temperature increase thereof).

In the example illustrated in FIG. 2, this exhaust duct 42 is connected to the exhaust line 16 (to one of the corresponding exhaust ducts 17) upstream of the after-treatment apparatus 8, so that the exhaust gases from the burner 9 reach the same after-treatment apparatus 8 via the exhaust line 16 (alternatively, the exhaust duct 42 could be connected to the after-treatment apparatus 8 in a direct manner, instead of indirectly via the exhaust line 16).

In a manner not illustrated in the aforementioned FIG. 2, the control unit (ECU) of the vehicle 1 is operatively coupled, inter alia, to the injector device 22 and the ignition device 40 of the burner 9, as well as to the aforementioned supply circuit 24 and the aforementioned supply line 30, in order to control the combustion within the burner 9 and to implement pre-heating of the associated after-treatment apparatus 8.

The monitoring system 10, coupled to the burner 9 and configured to monitor its operation, in particular the correct ignition of the air/fuel mixture within the combustion chamber 21, comprises a Lambda probe (or sensor) 44, configured to detect information associated with the combustion within the combustion chamber 21.

In particular, in the illustrated embodiment, the Lambda probe 44 is arranged at said exhaust duct 42 and is configured, inter alia, to detect the concentration of oxygen within the exhaust gases produced by the combustion within the burner 9.

According to an aspect of the present solution, the monitoring system 10 is configured to use the information provided by the Lambda probe 44 to estimate (indirectly) temperature information associated with the burner 9, in particular a temperature of the exhaust gases in the aforementioned exhaust duct 42.

Consequently, the monitoring system 10 is configured to monitor the correct ignition in the burner 9 based solely on the information provided by the Lambda probe 44, in particular without the use of a separate, additional temperature sensor.

As is known, the Lambda probe 44 internally comprises a heating element 50, for example consisting of a rod made of ceramic material integrated with an electric heater, which may for example consist of a wire of platinum or another resistive material. This heating element 50 can be controlled, in particular by means of a pulse-width-modulation (PWM) control signal, denoted in the figure with S_{PWM}, to pre-heat the Lambda probe 44, e.g. to a temperature of 750° C, by an electric current flowing through the same heating element 50.

The control signal S_{PWM} can for example be provided by the electronic control unit (ECU) of the vehicle 1 (here not shown).

The rapid pre-heating of the Lambda probe 44 to the desired temperature, implemented by means of a closed-loop control designed to generate the aforementioned control signal S_{PWM}, ensures the correct operation of the same Lambda probe 44. The aforementioned heating element 50 thus defines a resistive element internal to the Lambda probe 44, whose resistance value is influenced by the operating temperature at which the Lambda probe 44 operates (in particular, it varies according to the aforementioned temperature associated with the burner 9).

The Applicant has realized that it is possible to exploit the electrical behaviour of such heating element 50 to obtain an indirect estimate of the temperature associated with the Lambda probe 44 (and the burner 9), which can be used to monitor the correct combustion in the same burner 9.

In detail, the Applicant has realized that the aforementioned control signal S_{PWM} exhibits substantially different characteristics depending on whether or not a correct combustion has occurred within the burner 9 (i.e., a correct ignition of the air/fuel mixture in the relevant combustion chamber 21).

The aforementioned digital processing unit 12 of the monitoring system 10 is thus configured to monitor characteristics of the aforesaid control signal S_{PWM} and determine the correct combustion, based on the recognition of the aforesaid different characteristics of the control signal S_{PWM}.

In detail, the Applicant has found that the control signal S_{PWM} exhibits a different duty cycle (defined as the ratio between the on-interval and the off-interval within a single period of the same control signal S_{PWM}), depending on whether or not a correct combustion has occurred within the burner 9.

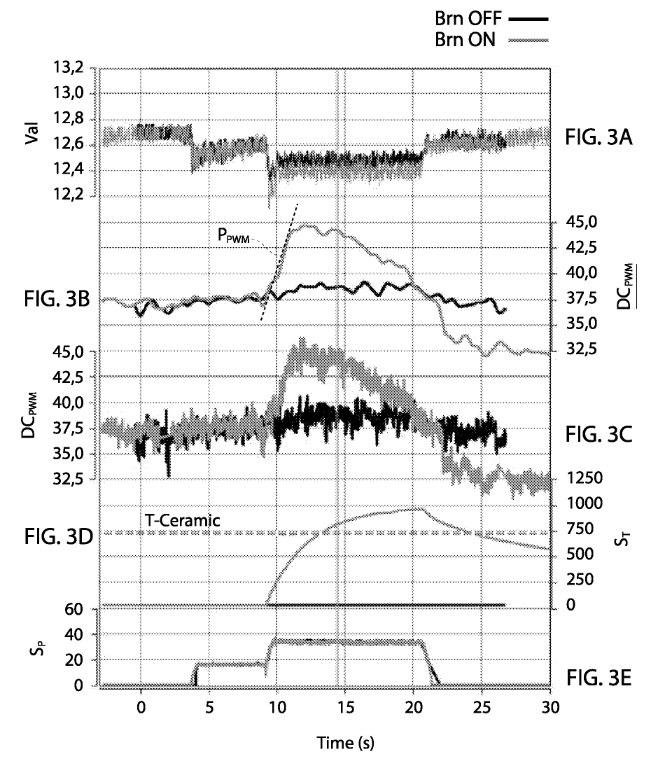

In this respect, FIGS. 3A-3E show the trend of some signals of interest related to the operation of the burner 9, in the two cases where a correct ignition occurs in the burner 9 (“BRN ON”) or where a correct combustion does not occur (“BRN OFF”).

In particular, FIG. 3A shows the trend of a supply voltage Val, which is supplied to the Lambda probe 44, e.g. from a battery of the vehicle 1.

FIG. 3B shows the filtered trend of the duty cycle, indicated as DC PWM , of the control signal S_{PWM} supplied to the Lambda probe 44 to control its heating element 50.

FIG. 3C shows the unfiltered trend of the same DC duty cycle_{PWM} of the control signal S_{PWM}.

FIG. 3D shows the trend of a temperature signal Sₜ, e.g. provided by the temperature sensor 18 placed at one of the exhaust ducts 17 of the exhaust line, upstream of the after-treatment apparatus 8. FIG. 3D also shows the trend of the internal temperature model of the heating element 50 of the Lambda probe 44, indicated by T_Ceramic.

Moreover, FIG. 3E shows the trend of an air flow rate signal Sₚ related to the flow of air fed to the burner 9, e.g. detected by the first transducer 26 of the aforementioned supply circuit 14 (in the example, the change in air flow rate at about second 9 determines when the burner 9 is ignited, or should be ignited).

From the trend of the aforementioned signals it is clear how, following the ignition of the burner 9, in the event of a correct combustion of the air/fuel mixture, there is a significant increase in the duty cycle of the control signal S_{PWM}, with the related duty cycle signal DC_{PWM} undergoing an increase with a slope (or derivative of the same duty cycle signal DC_{PWM}), indicated as P_{PWM} in FIG. 3B, which shows a significant variation.

On the contrary, in the event that a correct combustion does not occur, the same duty cycle signal DC_{PWM} remains substantially constant, with a substantially null or at least negligible slope value.

The variation in the duty cycle of the control signal S_{PWM} occurring in the case of correct ignition in the burner 9 can thus represent an indirect estimate of the temperature associated with the same burner (in the example illustrated, of a temperature rise due to correct ignition thereof).

The present Applicant has hypothesised that a possible cause of such an increase in the duty cycle of the control signal S_{PWM} can be related to the formation of water vapor due to the combustion and to the condensation of the same water vapor on the walls of the Lambda probe 44, which would lead to a decrease in temperature and a consequent increase in the heating action exerted by the heating element 50 (based on the related closed loop control), in order to keep the temperature of the same Lambda probe 44 substantially constant (T_Ceramic in the aforementioned FIG. 3D).

Also shown in the same FIG. 3D is the evident temperature increase at the after-treatment apparatus 8, in the case of a correct combustion in the burner 9.

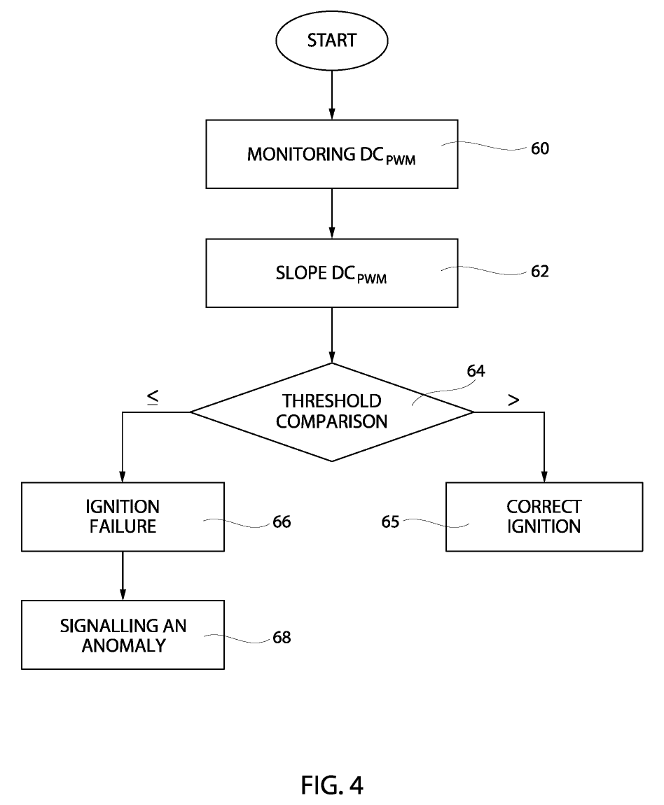

As shown in FIG. 4, in particular in step 60, the processing unit 12 of the monitoring system 10 is thus configured to monitor the trend of the control signal S_{PWM}, in particular of the associated duty cycle DC_{PWM}, following a desired ignition event of the burner 9 (e.g., according to the increase in the air flow rate fed to the same burner 9, highlighted by the trend of the air flow rate signal Sₚ).

Then, as shown in step 62, the processing unit 12 is configured to determine the relevant characteristics of the control signal trend S_{PWM}, in particular the slope (or derivative) of the associated duty cycle DC_{PWM}.

The processing unit 12 then performs a comparison, as shown in step 64, between this slope (or derivative) and a given threshold value.

In the case where, as shown in step 65, the slope (or derivative) is greater than the threshold value, the processing unit 12 is able to recognize the correct ignition of the burner 9 (i.e. the correct combustion of the air/fuel mixture); on the contrary, in the case where the same slope is less than or equal to the threshold value, the processing unit 12 is able to recognize a failed ignition of the burner 9, as shown in step 66.

In the latter case, the same processing unit 12 can be configured to output an alarm signal, e.g. to the electronic control unit (ECU) of the vehicle 1, in order to take appropriate action upon detection of the unsafe condition (due, precisely, to a failed combustion in the burner 9), as indicated in step 68.

The processing unit 12 can also utilise the oxygen concentration information provided by the Lambda probe 44 for the detection of the correct ignition in the burner 9, advantageously in conjunction with the monitoring of the aforesaid slope of the duty cycle DC_{PWM} of the control signal S_{PWM}.

From what has been discussed, the advantages of this solution are evident.

In any case, it is again emphasised that this solution allows combustion inside the burner 9 to be monitored reliably and efficiently, using only the information provided by the Lambda probe 44 (without requiring the use of a separate and additional temperature sensor), thus obtaining an important advantage in terms of the number of components and associated costs, especially in the case of multi-bank engines, and also in terms of control software simplification.

It is clear that changes and variations can be made to what has been described herein without departing from the scope of the present invention, as defined by the appended claims.

In particular, it is underlined again that the solution described can be advantageously applied in any type of vehicle, particularly motor vehicles, which use an internal combustion engine for their propulsion (possibly in combination with one or more electric motors).

1. A monitoring system configured to monitor the operation of a burner associated with an exhaust gas after-treatment apparatus for exhaust gases produced by an internal combustion engine of a vehicle, the monitoring system comprising:
a Lambda probe, coupled to the burner and configured to detect information associated with a combustion within the burner; and
a processing unit, operatively coupled to the Lambda probe and configured to use the information detected by the Lambda probe to indirectly estimate temperature information associated with the burner,
wherein said processing unit is configured to recognize a correct ignition of an air/fuel mixture within the burner and consequently a correct combustion, based on said temperature information.

2. The monitoring system according to claim 1, wherein said processing unit is configured to recognize said correct ignition using only the information detected by the Lambda probe, without the use of a separate and distinct temperature sensor.

3. The monitoring system according to claim 1, wherein said Lambda probe is arranged at an exhaust duct, designed for coupling the burner to the after-treatment apparatus, to feed exhaust gases produced by combustion in the burner to the post-treatment apparatus, in order to raise the temperature of said post-treatment apparatus; wherein said temperature associated with the burner is a temperature of the exhaust gases in the exhaust duct.

4. The monitoring system according to claim 1, wherein said Lambda probe internally includes a heating element, designed to be controlled by a pulse-width-modulation control signal, to pre-heat the Lambda probe to an operating temperature, by an electric current flowing through the heating element; wherein said heating element defines a resistive element internal to the Lambda probe, whose resistance value is influenced by said temperature associated with the burner; and wherein said processing unit is configured to obtain the indirect estimate of the temperature information associated with the burner based on an electrical behavior of the heating element.

5. The monitoring system according to claim 4, wherein said processing unit is configured to monitor characteristics of the control signal and recognize said correct ignition based on the recognition of different characteristics of the control signal, depending on whether or not a correct combustion of said mixture has occurred inside the burner.

6. The monitoring system according to claim 4, wherein said processing unit is configured to recognize said correct ignition as a function of a variation in a duty cycle of the control signal (S_{PWM}), depending on whether or not a correct combustion of said mixture has occurred inside the burner.

7. The monitoring system according to claim 6, wherein said processing unit is configured to monitor the trend of said duty cycle, following an event of desired ignition of the burner; determine slope characteristics of said duty cycle; and recognize a correct ignition of the burner in the event that said slope has a first relation with a threshold value.

8. The monitoring system according to claim 7, wherein said processing unit, in the event that said slope has a second relation with the threshold value, is configured to recognize a failed ignition of the burner and to generate an alarm signal.

9. A vehicle, comprising:
an internal combustion engine;
an exhaust gas after-treatment apparatus for exhaust gases produced by the internal combustion engine;
a burner associated with said after-treatment device; and
the monitoring system according to claim 1.

10. A method for monitoring an operation of a burner associated with an exhaust gas after-treatment apparatus for exhaust gases produced by an internal combustion engine of a vehicle, the method comprising:
detecting information associated with the combustion inside the burner by means of a Lambda probe;
using the information detected by the Lambda probe to indirectly estimate temperature information associated with the burner; and
recognizing a correct ignition of an air/fuel mixture inside the burner and consequently a correct combustion, based on said temperature information.

11. The method according to claim 10, wherein recognizing comprises using only the information detected by the Lambda probe, without using a separate and distinct temperature sensor.

12. The method according to claim 10, wherein said Lambda probe internally includes a heating element designed to be controlled by a pulse-width-modulation control signal to pre-heat the lambda probe to an operating temperature, by an electric current flowing through the heating element; wherein said heating element defines a resistive element inside the Lambda probe, whose resistance value is influenced by said temperature associated with the burner; and wherein recognizing comprises obtaining the indirect estimate of the temperature associated with the burner based on an electrical behavior of the heating element.

13. The method according to claim 12, wherein recognizing includes monitoring characteristics of the control signal and recognizing said correct ignition as a function of the recognition of different characteristics of the control signal (S_{PWM}), depending on whether or not a correct combustion of said mixture has occurred inside the burner.

14. The method according to claim 12, wherein recognizing comprises recognizing said correct ignition as a function of a variation in a duty cycle of the control signal (S_{PWM}), depending on whether or not a correct combustion of said mixture has occurred inside the burner.

15. The method according to claim 14, wherein recognizing comprises monitoring the trend of said duty cycle, following a desired ignition event of the burner determine slope characteristics of said duty cycle; and recognizing a correct ignition of the burner in the event that said slope has a first relation with a threshold value.
